(19) United States
(12) Patent Application Publication
(10) Pub. No.: US 2025/0329302 A1
(43) Pub. Date: Oct. 23, 2025

(54) DISPLAY DEVICE

(71) Applicant: InnoLux Corporation, Miao-Li County (TW)

(72) Inventors: Po-Yang CHEN, Miao-Li County (TW); Ting-Chia LIU, Miao-Li County (TW); Yu-Shih TSOU, Miao-Li County (TW); Yu-Chun HSU, Miao-Li County (TW); Wei-Ming CHU, Miao-Li County (TW); Yung-Hsin LU, Miao-Li County (TW)

(21) Appl. No.: 19/087,350

(22) Filed: Mar. 21, 2025

Related U.S. Application Data
(60) Provisional application No. 63/636,332, filed on Apr. 19, 2024.

(30) Foreign Application Priority Data
Oct. 24, 2024 (CN) 202411493252.2

(51) Int. Cl. G09G 3/34; G09G 3/3208

(52) U.S. Cl. CPC G09G 3/3406; G09G 3/3208; G09G 2320/0626; G09G 2320/0666; G09G 2320/0673; G09G 2340/06; G09G 2360/144

(57) ABSTRACT

A display device includes a color temperature sensor, a computing unit, a gamma unit and a display panel. The color temperature sensor is used to sense color temperature of ambient light, and output target white point information. The computing unit is coupled to the color temperature sensor for calculating adjustment factors corresponding to red, green and blue colors based on the target white point information. The gamma unit is coupled to the computing unit for receiving the adjustment factors and adjusting gamma curves corresponding to red, green and blue colors. The display panel includes a red sub-pixel, a green sub-pixel and a blue sub-pixel, wherein the display panel is coupled to the gamma unit for receiving an image signal, and providing data signal to the red sub-pixel, the green sub-pixel and the blue sub-pixel based on the gamma curves corresponding to red, green and blue colors.

### CROSS-REFERENCE TO RELATED APPLICATIONS

This application claims the benefit of filing date of U.S. Provisional Application Ser. No. 63/636,332 filed on Apr. 19, 2024 under 35 USC § 119(e)(1), and also claims the benefit of the Chinese Patent Application Serial Number 202411493252.2, filed on Oct. 24, 2024, the subject matters of which are incorporated herein by reference.

### BACKGROUND

### Field of the Disclosure

The present disclosure relates to a display device and, more particularly, to a display device capable of adjusting the display effect based on ambient light.

### Description of Related Art

In certain application scenarios of display devices, strong specular reflection light will reduce the visibility of the screen, making it difficult to read information. Although, in the existing method, a special coating is provided on the screen of the display device, it still produces a small amount of reflected light and glare, which results in that users are unable to obtain the same experience as viewing paper. In addition, the color temperature of the ambient light will also affect the display effect of the display device. The existing display devices are unable to provide different display effects as the color temperature of the ambient light changes, so that users often feel a lack of the sense of immersion.

Therefore, it is desired to provide a novel display device so as to alleviate and/or obviate the above problems.

### SUMMARY

The present disclosure provides a display device, which includes: a color temperature sensor, a computing unit, a gamma unit and a display panel. The color temperature sensor senses color temperature of ambient light and outputs target white point information. The computing unit is coupled to the color temperature sensor for calculating three adjustment factors corresponding to red, green and blue colors based on the target white point information. The gamma unit is coupled to the computing unit for receiving the three adjustment factors and adjusting gamma curves corresponding to red, green and blue colors. The display panel includes a red sub-pixel, a green sub-pixel and a blue sub-pixel, wherein the display panel is coupled to the gamma unit for receiving an image signal, and the display panel provides data signal to the red sub-pixel, the green sub-pixel and the blue sub-pixel based on the gamma curves corresponding to red, green and blue colors.

Other novel features of the disclosure will become more apparent from the following detailed description when taken in conjunction with the accompanying drawings.

### BRIEF DESCRIPTION OF DRAWINGS

FIG. 1A is a schematic diagram of a display device according to the first embodiment of the present disclosure;

FIG. 1B is a schematic diagram of the operation process of the computing unit according to the first embodiment of the present disclosure;

FIG. 2A is a schematic diagram of a display device according to a second embodiment of the present disclosure;

FIG. 2B is a schematic diagram of the operation process of the computing unit according to the second embodiment of the present disclosure;

FIG. 2C to FIG. 2E are schematic diagrams of the chromaticity, gamma curves and backlight brightness of the display panel according to an embodiment of the present disclosure;

FIG. 3A is a schematic diagram of a display device according to the third embodiment of the present disclosure;

FIG. 3B is a circuit diagram of one of a red sub-pixel, a green sub-pixel and a blue sub-pixel according to an embodiment of the present disclosure;

FIG. 3C is a signal timing diagram corresponding to one of the red sub-pixel, green sub-pixel and blue sub-pixel according to an embodiment of the present disclosure;

FIG. 4A is a schematic diagram of a display device according to the fourth embodiment of the present disclosure;

FIG. 4B is a schematic diagram of the operation process of the computing unit according to the fourth embodiment of the present disclosure;

FIG. 5 is a schematic diagram of a display device according to the fifth embodiment of the present disclosure;

FIG. 6A is a schematic diagram of a display device according to the sixth embodiment of the present disclosure;

FIG. 6B is a schematic diagram of gamma curves of a display panel according to an embodiment of the present disclosure;

FIG. 7 is a schematic diagram of a display device according to the seventh embodiment of the present disclosure;

FIG. 8A to FIG. 8C are schematic diagrams of a display device displaying color points of a white screen under different color temperatures of ambient light according to an embodiment of the present disclosure;

FIG. 9A to FIG. 9C are schematic diagrams of a display device displaying color points of original content under different color temperatures of ambient light according to an embodiment of the present disclosure;

FIG. 10A is a schematic structural diagram of a display device according to an embodiment of the present disclosure;

FIG. 10B is a schematic structural diagram of a display device according to another embodiment of the present disclosure;

FIG. 10C is a schematic structural diagram of a display device according to another embodiment of the present disclosure;

FIG. 11A and FIG. 11B are schematic structural diagrams respectively illustrating a protective layer and an anti-glare layer according to an embodiment of the present disclosure; and

FIG. 11C and FIG. 11D are schematic structural diagrams respectively illustrating a protective layer and an anti-glare layer according to another embodiment of the present disclosure.

### DETAILED DESCRIPTION OF EMBODIMENT

Reference will now be made in detail to exemplary embodiments of the present application, examples of which are illustrated in the accompanying drawings. Wherever possible, the same reference numerals are used in the drawings and description to refer to the same or like parts.

Throughout the specification and the appended claims, certain terms may be used to refer to specific components. Those skilled in the art will understand that electronic device manufacturers may refer to the same components by different names. The present application does not intend to distinguish between components that have the same function but have different names. In the following description and claims, words such as “containing” and “comprising” are open-ended words, and should be interpreted as meaning “including but not limited to”.

The terms, such as “about”, “substantially”, or “approximately” are generally interpreted as within 10% of a given value or range, or as within 5%, 3%, 2%, 1% or 0.5% of a given value or range.

In the specification and claims, unless otherwise specified, ordinal numbers, such as “first” and “second”, used herein are intended to distinguish components rather than disclose explicitly or implicitly that names of the components bear the wording of the ordinal numbers. The ordinal numbers do not imply what order a component and another component are in terms of space, time or steps of a manufacturing method. Thus, what is referred to as a “first component” in the specification may be referred to as a “second component” in the claims.

In the present application, the terms “the given range is from the first numerical value to the second numerical value” and “the given range falls within the range from the first numerical value to the second numerical value” mean that the given range includes the first numerical value, the second numerical value, and other values between the first and second numerical values.

In addition, the display device disclosed in the present disclosure may be applied to electronic devices. The electronic device may include exposure device, printing device, three-dimensional printing device, automotive device, imaging device, assembly device, backlight device, antenna device, tiled device, touch electronic device, curved electronic device or free shape electronic device, but not limited thereto. The display device may include, for example, liquid crystal, light emitting diode, fluorescence, phosphor, other suitable display media, or a combination of the above, but not limited thereto. The display device may be a non-self-luminous display device or a self-luminous display device. The antenna device may be a liquid crystal type antenna device or a non-liquid crystal type antenna device, and the sensing device may be a sensing device that senses capacitance, light, heat energy or ultrasonic waves, but not limited thereto. The tiled device may include, for example, a display tiled device or an antenna tiled device, but not limited thereto. It should be noted that the electronic device may be any combination of the above, but not limited thereto. In addition, the electronic device may be a bendable or flexible electronic device. It should be noted that the electronic device may be any combination of the above, but not limited thereto. In addition, the shape of the electronic device may be a rectangular shape, a circular shape, a polygonal shape, a shape with curved edges, or other suitable shapes. The electronic device may have a peripheral system such as drive system, control system, light source system, shelf system, etc. to support the display device, antenna device or tiled device.

It should be noted that the following embodiments may be replaced, reorganized, and mixed to complete other embodiments without departing from the spirit of the present disclosure. As long as the features of the various embodiments do not violate the spirit of the invention or conflict with each other, they can be mixed and matched arbitrarily

Unless otherwise defined, all terms (including technical and scientific terms) used herein have the same meaning as commonly understood by one of ordinary skill in the art to which this disclosure belongs. It may be understood that these terms, such as those defined in commonly used dictionaries, should be interpreted as having meanings consistent with the background or context of the related technology and the present disclosure, and should not be interpreted in an idealized or overly formal manner, unless otherwise specified in the embodiments of the present disclosure.

In addition, the term “adjacent” in the specification and claims is used to describe mutual proximity, and does not necessarily mean mutual contact.

In addition, the descriptions such as “when” or “during” in the present disclosure represent aspects such as “now, before or after”, and are not limited to situations that occur at the same time, which is described first here. In the present disclosure, similar descriptions such as “arranged on” refer to the corresponding positional relationship between the two components, and do not limit whether there is contact between the two components, unless otherwise specified, which is described here first. Furthermore, when the present disclosure discloses multiple functions, if the word “or” is used between the functions, it means that the functions may exist independently, but it does not exclude that multiple functions may exist simultaneously.

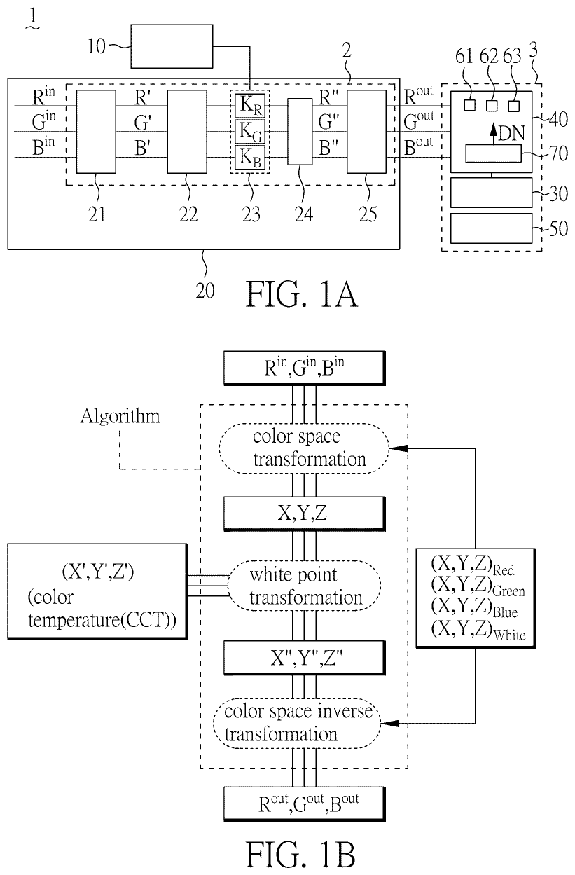

FIG. 1A is a schematic diagram of a display device 1 according to the first embodiment of the present disclosure. FIG. 1B is a schematic diagram of the operation process of the computing unit 20 according to the first embodiment of the present disclosure.

As shown in FIG. 1A, the display device 1 may include a color temperature sensor 10, a computing unit 20, a gamma unit 30, a display panel 40 and a backlight unit 50. The computing unit 20 is coupled to the color temperature sensor 10. The display panel 40 is coupled to the computing unit 20 and the gamma unit 30. The computing unit 20 may include a tone reproduction curve (TRC) transformation module 21, a color space transformation module 22, a white point transformation module 23, a color space inverse transformation module 24 and a TRC inverse transformation module 25. The display panel 40 may include an array area (not shown), and the array area may include at least one red sub-pixel 61, at least one green sub-pixel 62, and at least one blue sub-pixel 63. It should be noted that the number of sub-pixels 61 to 63 in the figures is not limited, and the present disclosure may actually have a larger number of sub-pixels 61 to 63. In one embodiment, the display panel 40 may further include a driving unit 70. In addition, it should be noted that the component proportions presented in the figures do not represent actual proportions.

Regarding the functions of the above components, in one embodiment, the color temperature sensor 10 may be used to sense the color temperature of the ambient light, and output target white point information based on the sensed color temperature, which may be, for example, implemented by using the color temperature sensor 10 to execute a preset algorithm, while it is not limited thereto. The computing unit 20 may calculate three adjustment factors corresponding to red, green and blue colors based on the target white point information. For example, the TRC transformation module 21 may be used to perform a TRC transformation (shown in FIG. 1A) on a signal (for example, an original image signal provided by a signal source), the color space transformation module 22 may be used to transform the signal after TRC transformation into a color point in a color space (shown in FIG. 1B), the white point transformation module 23 may be used to calculate a plurality of adjustment factors based on the target white point information, and utilize the adjustment factors to adjust the color point, the color space inverse transformation module 24 may transform the adjusted color point into a new signal, and the TRC inverse transformation module 25 may perform TRC inverse transformation on the new signal so as to generate an image signal. The display panel 40 may receive the image signal and gamma curves provided by the gamma unit 30, wherein the driving unit 70 of the display panel 40 may generate data signal DN based on the image signal and the gamma curves, and may transmit the data signal DN to red sub-pixel 61, green sub-pixel 62 and blue sub-pixel 63. In one embodiment, the data signal DN may include three sub-signals respectively corresponding to the red sub-pixel 61, the green sub-pixel 62 and the blue sub-pixel 63, but it is not limited thereto.

In one embodiment, when the display panel 40 displays a solid color screen, the computing unit 20 may obtain the information of a color space corresponding to the display panel 40 (for example, obtain the information of the red solid color screen in the color space respectively (X,Y,Z)_{Red}, obtain the information of the green solid color screen in the color space (X,Y,Z)_{Green}, obtain the information of the blue solid color screen in the color space (X,Y,Z)_{Blue}, and obtain the information of the white solid color screen in the color space (X, Y, Z)_{White}, the color space transformation module 22 may be used to transform a signal (for example, signal after TRC transformation) into a color point in the color space so as to provide color gamut information, and the color space inverse transformation module 24 may transform the color point in the color space back to the format of the TRC signal. In addition, in one embodiment, the white point transformation module 23 uses the target white point information and the information of the color space corresponding to the display panel 40 to calculate the adjustment factor, wherein the adjustment factor may be regarded as the difference between the color temperatures of the solid color screen displayed by the display panel 40 and the color temperature of the ambient light, while it is not limited thereto.

In one embodiment, the computing unit 20 may be, for example but not limited to, a processor, a chip or a system on chip (SOC), wherein the TRC transformation module 21, the color space transformation module 22, the white point transformation module 23, the color space inverse transformation module 24, the TRC inverse transformation module 25 or other functions can be implemented by the computing unit 20 executing one or more algorithms 2, while it is not limited thereto. In addition, in one embodiment, the gamma unit 30 may be, for example, disposed in a timing controller (not shown), wherein the functions of the gamma unit 30 described herein may be implemented by a processor in the timing controller (not shown) performing functions, while it is not limited thereto. The backlight unit 50 may be, for example, a backlight panel, but it is not limited thereto. In one embodiment, the gamma unit 30, the display panel 40 and/or the backlight unit 50 may be regarded as at least part of a display module 3, while it is not limited thereto.

Next, the operation of the computing unit 20 will be described. As shown in FIG. 1A and FIG. 1B, in one embodiment, a signal source (not shown) may provide original image signal (Rⁱⁿ, Gⁱⁿ, Bⁱⁿ) to the computing unit 20, wherein the original image signal (Rⁱⁿ, Gⁱⁿ, Bⁱⁿ) may include a sub-signal Rᵢₙ for the red sub-pixel 61, a sub-signal Gⁱⁿ for the green sub-pixel 62, and a sub-signal Bⁱⁿ for the blue sub-pixel 63. In one embodiment, the sub-signals Rⁱⁿ, Gⁱⁿ and Bⁱⁿ respectively correspond to gray-scale values of red, green and blue colors, but it is not limited thereto. In addition, the color temperature sensor 10 may sense the color temperature of the ambient light to output target white point information, for example, at least one of (X′, Y′, Z′) and color temperature (hereinafter represented by (CCT (correlated color temperature))), but not limited thereto. In addition, the computing unit 20 may obtain the information of the color space corresponding to the display panel 40 displaying a solid color screen, and obtain an actual white point in the color space, wherein the actual white point and the target white point information (at least one of (X′, Y′, Z′) and (CCT), but not limited thereto) may be regarded as the difference between the color temperature of the screen displayed on the display panel 40 and the color temperature of the ambient light, while it is not limited thereto. Then, the TRC transformation module 21 may perform TRC transformation on the original image signal (Rⁱⁿ, Gⁱⁿ, Bⁱⁿ) to form a first transformation signal (R′, G′, B′). Then, the color space transformation module 22 may transform the first transformation signal (R′, G′, B′) into color point (X, Y, Z) in the color space corresponding to the display panel 40. Then, the white point transformation module 23 may calculate three adjustment factors K_{R}, K_{G}, K_{B} corresponding to red, green and blue colors based on the target white point information (at least one of (X′, Y′, Z′) and (CCT), and not limited thereto), wherein the white point transformation module 23 may perform white point transformation on the actual white point based on the target white point information (at least one of (X′, Y′, Z′) and (CCT), but not limited thereto), and respectively obtain the three adjustment factors K_{R}, K_{G} and K_{B} corresponding to red, green, and blue colors from the transformation process, while it is not limited thereto. Then, the white point transformation module 23 uses the three adjustment factors K_{R}, K_{G} and K_{B} corresponding to red, green and blue colors to transform the color point (X, Y, Z), so that the color point (X, Y, Z) is adjust to a first transformation color point (X″, Y″, Z″). The color space inverse transformation module 24 may transform the first transformation color point (X″, Y″, Z″) into a second transformation signal (R″, G″, B″). The TRC inverse transformation module 25 may perform TRC inverse transformation on the second transformation signal (R″, G″, B″) so as to generate an image signal (R^{out}, G^{out}, B^{out}) provided to the display panel 40. Then, the driving unit 70 of the display panel 40 may generate data signal DN for the red sub-pixel 61, the green sub-pixel 62 and the blue sub-pixel 63 respectively based on the image signal (R^{out}, G^{out}, B^{out}) and the gamma curves provided by the gamma unit 30.

Through the operation of the computing unit 20, the original image signal (Rⁱⁿ, Gⁱⁿ, Bⁱⁿ) may be transformed into new image signal (R^{out}, G^{out}, B^{out}) based on the color temperature of the current ambient light, so that the color temperature of the screen displayed on the display panel 40 may be closer to the color temperature of ambient light, thereby improving the display quality of the display device 1.

In one embodiment, through the operation of color temperature transformation of the aforementioned computing unit 20, since the original image signal (Rⁱⁿ, Gⁱⁿ, Bⁱⁿ) is transformed, when the color temperature of the screen displayed on the display panel 40 decreases after transformation, the color quantity displayed by the display panel 40 may decrease as the color temperature decreases. In addition, the backlight brightness in the display panel 40 may also decrease as the color temperature decreases. In addition, the gamma curves corresponding to the sub-signals R^{out}, G^{out} and B^{out} in the image signal (R^{out}, G^{out}, B^{out}) obtained by the display panel 40 are in consistency, while it is not limited thereto.

Accordingly, the first embodiment can be understood.

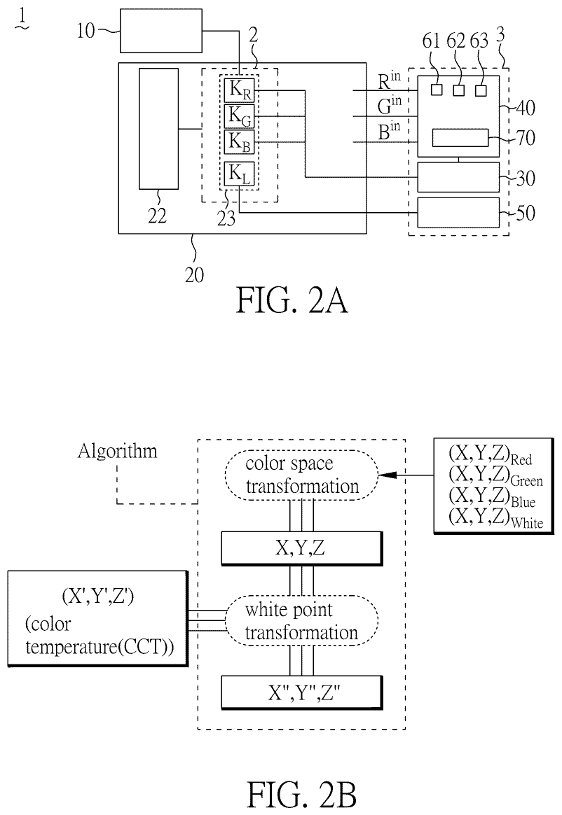

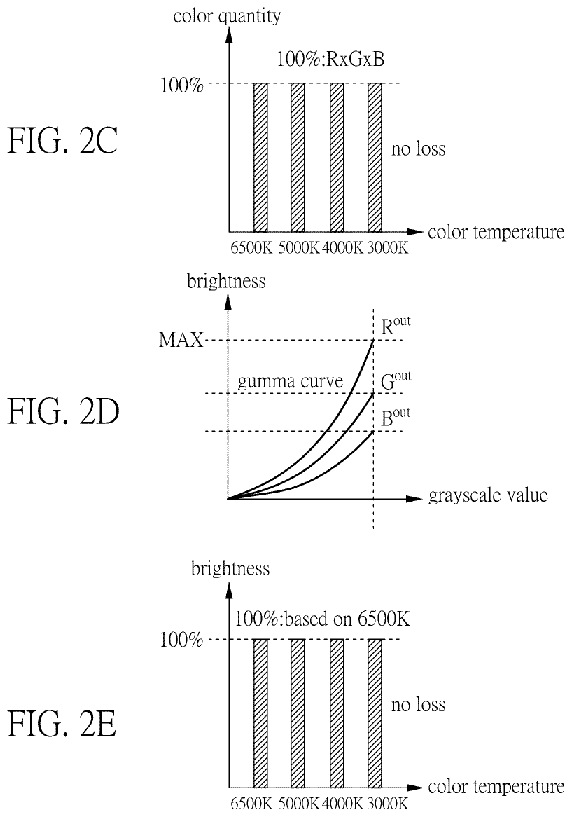

FIG. 2A is a schematic diagram of the display device 1 according to the second embodiment of the present disclosure, and FIG. 2B is a schematic diagram of the operation process of the computing unit 20 according to the second embodiment of the present disclosure. The description of the embodiment of FIG. 2A may generally be applicable to the embodiment of FIG. 1A, and thus the following description mainly focuses on the differences.

As shown in FIG. 2A, the display device 1 may include a color temperature sensor 10, a computing unit 20, a gamma unit 30, a display panel 40 and a backlight unit 50. The display panel 40 includes red sub-pixels 61, green sub-pixels 62 and blue sub-pixels 63. Different from the embodiment of FIG. 1A, the computing unit 20 of the embodiment of FIG. 2A may include a color space transformation module 22 and a white point transformation module 23, and the gamma unit 30 and the backlight unit 50 may be coupled to the computing unit 20. In addition, the image signal input to the display panel 40 may be original image signal (Rⁱⁿ, Gⁱⁿ, Bⁱⁿ).

Next, the detailed operations of the display device 1 and the computing unit 20 will be described. As shown in FIG. 2A and FIG. 2B, in one embodiment, the color temperature sensor 10 senses the color temperature of the ambient light to output the target white point information (at least one of (X′, Y′, Z′) and (CCT), but not limited thereto), and the computing unit 20 may obtain the information of the color space corresponding to the display panel 40 displaying a solid color screen. Then, the color space transformation module 22 may find an actual white point (not shown) from the color space corresponding to the display panel 40. Then, the white point transformation module 23 may calculate three adjustment factors K_{R}, K_{G}, K_{B} corresponding red, green and blue colors and one brightness adjustment factor K_{L} based on the target white point information (at least one of (X′, Y′, Z′) and (CCT), but not limited thereto), in which, based on the target white point information (at least one of (X′, Y′, Z′) and (CCT), but not limited thereto), the white point transformation module 23 may perform white point transformation on the actual white point (for example, for finding the difference between the target white point information (at least one of (X′, Y′, Z′) and (CCT), but not limited there) and the actual white point), and calculate the three adjustment factors K_{R}, K_{G}, K_{B} corresponding to red, green and blue colors and the brightness adjustment factor K_{L} from the transformation process, while it is not limited thereto. The signal source (not shown) may directly provide original image signal (Rⁱⁿ, Gⁱⁿ, Bⁱⁿ) to the display panel 40. The computing unit 20 may provide the three adjustment factors K_{R}, K_{G} and K_{B} corresponding to red, green and blue colors to the gamma unit 30, and the computing unit 50 may provide the brightness adjustment factor K_{L} to the backlight unit 50. The gamma unit 30 may adjust the gamma curves to be provided to the driving unit 70 based on the three adjustment factors K_{R}, K_{G} and K_{B} corresponding to red, green and blue colors. The driving unit 70 generates the data signal DN based on the original image signal (Rⁱⁿ, Gⁱⁿ, Bⁱⁿ) and the adjusted gamma curves, and provides the data signal DN to the red sub-pixel 61, the green sub-pixel 62 and the blue sub-pixel 63. The backlight unit 50 adjusts the backlight brightness provided to the display panel 40 based on the brightness adjustment factor K_{L}.

Through the operation of the computing unit 20, the gamma unit 30 may adjust the gamma curves based on the color temperature of the ambient light, and the backlight unit 50 may adjust the backlight brightness based on the color temperature of the ambient light, so that the color temperature of the screen displayed on the display panel 40 may be close to the color temperature of ambient light thereby improving the display quality of the display device 1.

FIG. 2C to FIG. 2E are schematic diagrams of the chromaticity, gamma curves and backlight brightness of the display panel 40 according to an embodiment of the present disclosure, which correspond to FIGS. 2A and 2B and are respectively used to display, after operation of the computing unit 20, the change of the chromaticity, gamma curves and backlight brightness of the display panel 40 when the color temperature of the ambient light changes.

As shown in FIG. 2C, in this embodiment, the original image signal (Rⁱⁿ, Gⁱⁿ, Bⁱⁿ) is not transformed during the operation of the computing unit 20 but are directly received by the display panel 40. Therefore, when the color temperature of the screen displayed by the panel 40 is reduced through transformation, the color quantity of the display panel 40 may be maintained without being reduced. In addition, as shown in FIG. 2D, after the operation of the computing unit 20, three gamma curves corresponding to red, green and blue colors provided by the gamma unit 30 based on the three adjustment factors K_{R}, K_{G} and K_{B} corresponding to red, green and blue colors are in a non-linear state; that is, the gamma unit 30 may adjust the gamma curves based on the color temperature of the ambient light. In addition, as shown in FIG. 2E, after the operation of the computing unit 20, when the color temperature of the screen displayed by the display panel 40 is reduced after transformation, the backlight unit 50 may adjust the backlight brightness so that the backlight brightness of the display panel 40 remains unchanged, while it is not limited thereto.

Accordingly, the second embodiment can be understood.

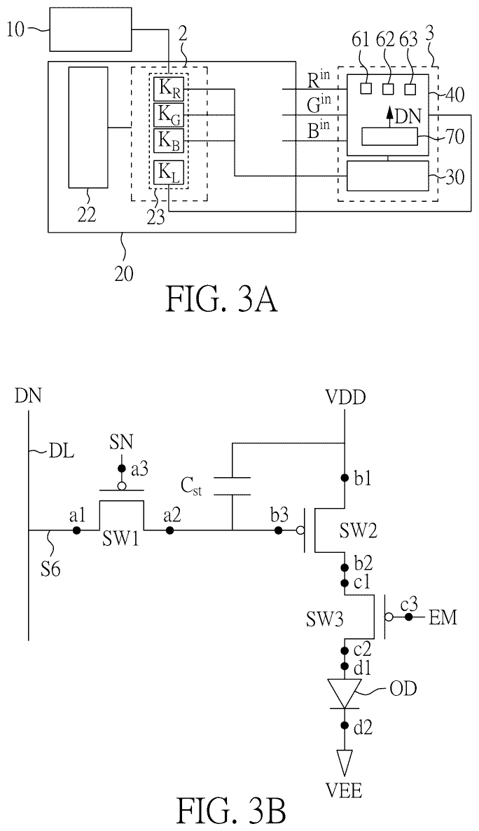

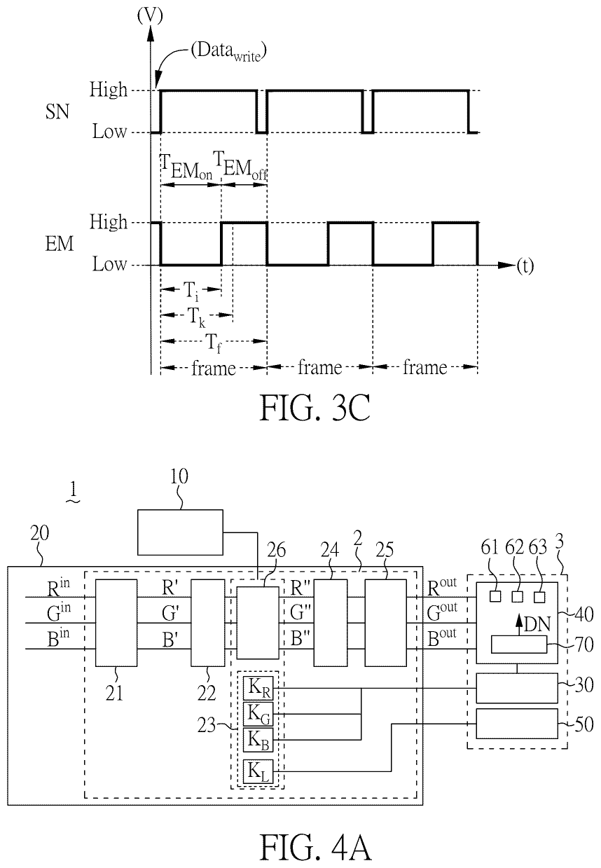

The display device 1 of the present disclosure may have different implementation aspects. FIG. 3A is a schematic diagram of the display device 1 according to the third embodiment of the present disclosure. The description of the embodiment of FIG. 3A is generally applicable to the embodiment of FIG. 2A, and thus the following description mainly focuses on the differences.

In the embodiment of FIG. 3A, the display panel 40 is a self-luminous display panel, so that the display device 1 may include a color temperature sensor 10, a computing unit 20, a gamma unit 30 and a display panel 40, wherein the display panel 40 includes red sub-pixel 61, green sub-pixel 62 and blue sub-pixel 63, and each of the red sub-pixel 61, the green sub-pixel 62 and the blue sub-pixel 63 may, for example, include a self-luminous unit, and the self-luminous unit may be, for example, an organic light emitting diode (OLED), but it is not limited thereto. Similar to the embodiment of FIG. 2A, the computing unit 20 of the embodiment of FIG. 3 may include a color space transformation module 22 and a white point transformation module 23, and the gamma unit 30 may be coupled to the computing unit 20. In addition, the original image signal (Rⁱⁿ, Gⁱⁿ, Bⁱⁿ) may be directly input to the display panel 40 without transformation. In addition, since the display panel 40 of this embodiment is a self-luminous display panel, there is no need to include the backlight unit 50 of the previous embodiment.

Next, the operation of the computing unit 20 will be described, and please refer to FIG. 2B and FIG. 3A at the same time. In one embodiment, the color temperature sensor 10 may sense the color temperature of the ambient light to output target white point information (at least one of (X′, Y′, Z′) and (CCT), but not limited thereto), and the computing unit 20 may obtain the information of the color space corresponding to the display panel 40 displaying a solid color screen. Then, the color space transformation module 22 may find the actual white point from the color space corresponding to the display panel 40. Then, the white point transformation module 23 may calculate three adjustment factors K_{R}, K_{G}, K_{B} corresponding red, green and blue colors, and brightness adjustment factor K_{L} based on the target white point information (at least one of (X′, Y′, Z′) and (CCT), but not limited thereto), in which the white point transformation module 23 may perform white point transformation on the actual white point based on at least one of the target white point information ((X′, Y′, Z′) and (CCT), but not limited thereto), and calculate the three adjustment factors K_{R}, K_{G}, K_{B} and the brightness adjustment factor K_{L} corresponding to red, green and blue colors from the transformation process, while it is not limited thereto. The signal source (not shown) may provide original image signal (Rⁱⁿ, Gⁱⁿ, Bⁱⁿ) to the display panel 40. The computing unit 20 may provide the three adjustment factors K_{R}, K_{G} and K_{B} corresponding to red, green and blue colors to the gamma unit 30, and the computing unit 20 may provide the brightness adjustment factor K_{L} to the display panel 40. The gamma unit 30 may adjust the gamma curves to be provided to the driving unit 70 based on the three adjustment factors K_{R}, K_{G} and K_{B} corresponding to red, green and blue colors. The driving unit 70 generates the data signal DN based on the original image signal (Rⁱⁿ, Gⁱⁿ, Bⁱⁿ) and the adjusted gamma curves, and provides the data signal DN to the red sub-pixel 61, the green sub-pixel 62 and the blue sub-pixel 63. In addition, the display panel 40 receives the brightness adjustment factor K_{L}, and adjusts the brightness of the red sub-pixel 61, the green sub-pixel 62 and the blue sub-pixel 63 based on the brightness adjustment factor K_{L}.

Next, the details of the display panel 40 adjusting the brightness of the red sub-pixel 61, the green sub-pixel 62 and the blue sub-pixel 63 based on the brightness adjustment factor K_{L} are further described. FIG. 3B is a circuit diagram of one of the red sub-pixel 61, the green sub-pixel 62 and the blue sub-pixel 63 (hereinafter referred to as the sub-pixel) according to an embodiment of the present disclosure. FIG. 3C is a signal timing diagram corresponding to the sub-pixel according to an embodiment of the present disclosure.

As shown in FIG. 3B, the circuit structure of the sub-pixel may include a data writing transistor SW1, a driving transistor SW2, an emission transistor SW3 and a light emitting unit OD. The data writing transistor SW1 may include a first end a1, a second end a2 and a control end a3. The driving transistor SW2 may include a first end b1, a second end b2 and a control end b3. The emission transistor SW3 may include a first end c1, a second end c2 and a control end c3. The light emitting unit OD may include a first end d1 and a second end d2.

In one embodiment, the first end a1 of the data writing transistor SW1 may be coupled to a data line DL for receiving the data signal DN, the second end a2 of the data writing transistor SW1 may be coupled to the control end b3 of the driving transistor SW2, and the control end a3 of the data writing transistor SW1 may be coupled to a scan line SL for receiving a scan signal SN. The first end b1 of the driving transistor SW2 may be coupled to a high voltage level signal VDD, and a capacitor Cst may be disposed between the second end a2 of the data writing transistor SW1 and the first end b1 of the driving transistor SW2. The second end b2 of the driving transistor SW2 may be coupled to the first end c1 of the emission transistor SW3. The emission transistor SW3 is coupled between the driving transistor SW2 and the light emitting unit OD for receiving the brightness adjustment factor K_{L}. For example, the second end c2 of the emission transistor SW3 may be electrically connected to the first end d1 of the light emitting unit OD, the control end c3 of the emission transistor SW3 may be used to receive a control signal EM, and the control signal EM is adjusted based on the brightness adjustment factor K_{L}, while it is not limited thereto. The second end d2 of the light emitting unit OD may be electrically connected to a low voltage level signal VEE.

In addition, in FIG. 3B, the data writing transistor SW1, the driving transistor SW2 and the emission transistor SW3 are exemplified by the PMOS architecture, so that the aforementioned transistors SW1-SW3 are turned on when the control end a3, b3 or c3 receives signal of low voltage level, and are turned off when the control end a3, b3 or c3 receives signal of high voltage level, while it is not limited thereto.

As shown in FIG. 3C, in one embodiment, during a data writing period (denoted as Data_{write}) during a frame (denoted as frame), the scanning signal SN is at a low voltage level. At this moment, the data writing transistor SW1 is turned on, the transistors SW2 and SW3 are turned off, and the data signal DN may be obtained by the data writing transistor SW1. Then, under the influence of the data writing transistor SW1, the driving transistor SW may be turned on. Then, in an emission period, the scan signal SN changes from a low voltage level to a high voltage level, so the data writing transistor SW1 is turned off, and the control signal EM received by the control end c3 of the emission transistor SW3 changes from a high voltage level to a low voltage level, so that the emission transistor SW3 is turned on (this period is denoted as T_{EMon}). At this moment, the specific current determined by the data signal DN is transmitted to the light emitting unit OD through the driving transistor SW2 and the emission transistor SW3, thereby causing the light emitting unit OD to emit light. When the control signal EM changes from a low voltage level back to a high voltage level, the emission transistor SW3 is turned off (this period is denoted as T_{EMoff}).

Furthermore, in one embodiment, by adjusting the duty of the low voltage level period of the control signal EM in a frame period, the brightness of the light emitted by the light emitting unit OD may be adjusted. In one embodiment, the control signal EM is adjusted based on the brightness adjustment factor K_{L}, thereby adjusting the brightness of the display panel 40. As shown in FIG. 3C, the low voltage level period of the control signal EM in the frame period is denoted as T_{EMon}, the high voltage level period of the control signal EM in the frame period is denoted as T_{EMoff}, and the time length of the low voltage level period T_{EMon} of the control signal EM is denoted as Ti, the time length of the low voltage level period T_{EMon} of the control signal EM adjusted based on the brightness adjustment factor K_{L} is denoted as Tₖ, and the time length of the frame period is denoted as T_{f}. In one embodiment, the parameters of the duty ratio PWM of the control signal EM satisfy the following conditions:

$$PWM = \frac{{T}_{EMon}}{{T}_{f}} ,$$

$${K}_{L} = \frac{{T}_{k}}{{T}_{i}} = \frac{\frac{{T}_{k}}{{T}_{f}}}{\frac{{T}_{i}}{{T}_{f}}} = \frac{{PWM}_{k}}{{PWM}_{i}} ,$$

where K_{L} is the brightness adjustment factor, PWM is the duty ratio of the control signal EM, PWMₖ is the duty ratio of the control signal EM adjusted based on the brightness adjustment factor K_{L}, and PWMᵢ is the duty cycle of the initial control signal EM.

Accordingly, the third embodiment can be understood.

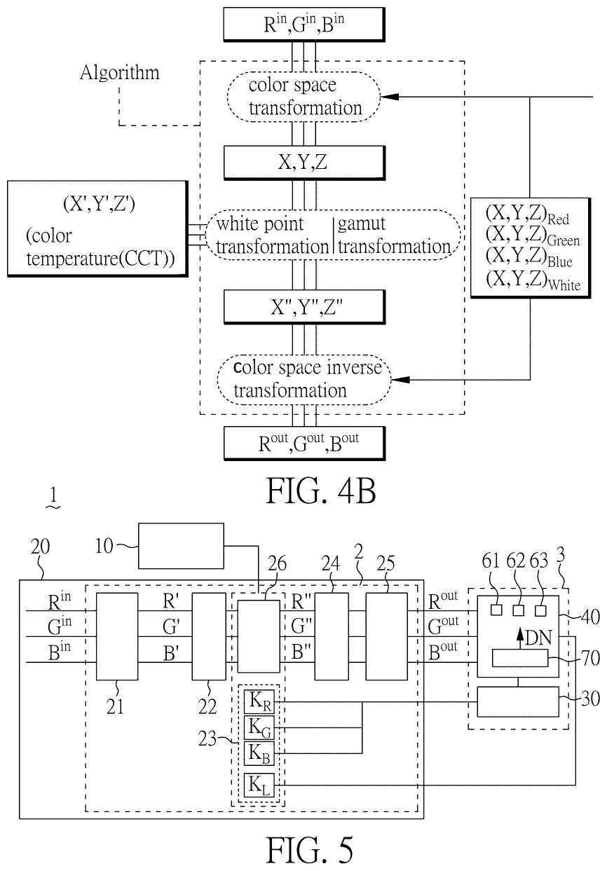

The display device 1 of the present disclosure may have different implementation aspects. FIG. 4A is a schematic diagram of the display device 1 according to the fourth embodiment of the present disclosure. The description of the embodiment in FIG. 4A is generally applicable to the embodiment in FIG. 1A, and thus the following description mainly focuses on the differences.

As shown in FIG. 4A, the display device 1 may include a color temperature sensor 10, a computing unit 20, a gamma unit 30, a display panel 40 and a backlight unit 50. The computing unit 20 is coupled to the color temperature sensor 10. The display panel 40 is coupled to the computing unit 20 and the gamma unit 30. The computing unit 20 may include a TRC transformation module 21, a color space transformation module 22, a white point transformation module 23, a color space inverse transformation module 24, and a TRC inverse transformation module 25. In addition, the computing unit 20 may also include a color gamut transformation module 26. The display panel 40 may include red sub-pixels 61, green sub-pixels 62 and blue sub-pixels 63 and a driving unit 70. The color gamut transformation module 26 may be coupled to the color temperature sensor 10.

In one embodiment, the display device 1 may be used to display an image corresponding to an original content, wherein the original content may include a photo, a painting or a picture, while it is not limited thereto. Typically, the image of the original content may have a color gamut that is narrower or has a smaller color range. For example, the original content may have less vivid colors or a lower color range. Therefore, when the original image signal (Rⁱⁿ, Gⁱⁿ, Bⁱⁿ) is an image signal corresponding to the display of the original content, although the color space transformation module 22 may transform the original image signal (Rⁱⁿ, Gⁱⁿ, Bⁱⁿ) to the corresponding color space of the display panel 40, it may sometimes happen that the color gamut in the color space corresponding to the display panel 40 is too wide or the color range is too large, so that the color changes of the original content cannot be accurately represented. Therefore, there will be a discrepancy between the color distribution of the image displayed by the display panel 40 and the original content. In this embodiment, the signal after color space transformation may then be subject to a color gamut transformation (GCM) through the color gamut transformation module 26 for being transformed into a color gamut corresponding to the image of the original content, for example, a color gamut with narrower color range or less color range. In one embodiment, the color gamut transformation module 26 may include information of a target color gamut of the original content under ambient light, while it is not limited thereto. It can be seen from this that the computing unit 20 may transform the original image signal (Rⁱⁿ, Gⁱⁿ, Bⁱⁿ) based on the target color gamut information provided by the color gamut transformation module 26 and the target white point information output by the color temperature sensor 10 to form image signal (R^{out}, G^{out}, B^{out}) so as to enable the color temperature and color distribution of the screen displayed on the display panel 40 to be close to the appearance of the entity (such as a physical photo, painting or picture) of the original content under ambient light.

Next, the detailed operations of the display device 1 and the computing unit 20 will be described. FIG. 4B is a schematic diagram of the operation process of the computing unit 20 according to the fourth embodiment of the present disclosure, and please refer to FIG. 4A at the same time.

As shown in FIG. 4A and FIG. 4B, in one embodiment, a signal source (not shown) may provide original image signal (Rⁱⁿ, Gⁱⁿ, Bⁱⁿ) to the computing unit 20. In addition, the color temperature sensor 10 may sense the color temperature of ambient light to output target white point information (at least one of (X′, Y′, Z′) and (CCT), but not limited thereto). In addition, the computing unit 20 may obtain the information of the color space corresponding to the display panel 40 displaying a solid color screen, and obtain an actual white point in the color space. Then, the TRC transformation module 21 may perform TRC transformation on the original image signal (Rⁱⁿ, Gⁱⁿ, Bⁱⁿ) to form the first transformation signal (R′, G′, B′). Then, the color space transformation module 22 may transform the first transformation signal (R′, G′, B′) into color point (X, Y, Z) in the corresponding color space of the display panel 40. Then, the white point transformation module 23 may calculate three adjustment factors K_{R}, K_{G}, K_{B} corresponding red, green and blue colors based on the target white point information (at least one of (X′, Y′, Z′) and (CCT), but not limited thereto), in which, based on the target white point information (at least one of (X′, Y′, Z′) and (CCT), but not limited thereto), the white point transformation module 23 may perform white point transformation on the actual white point (for example, for finding the difference between the target white point information (at least one of (X′, Y′, Z′) and (CCT), but not limited thereto) and the actual white point), and calculate the three adjustment factors K_{R}, K_{G}, K_{B} and the brightness adjustment factor K_{L} corresponding to red, green and blue colors from the transformation process, while it is not limited thereto. Then, the computing unit 20 may transmit the three adjustment factors K_{R}, K_{G} and K_{B} corresponding to red, green and blue colors to the gamma unit 30, and transmit the brightness adjustment factor K_{L} to the backlight unit 50. In addition, the color gamut transformation module 26 may perform color gamut transformation on the color point (X, Y, Z) based on the target color gamut so as to form a color point after color gamut transformation (not shown). Then, through the operation of the color space inverse transformation module 24 and the TRC inverse transformation module 25 (please refer to the previous embodiment), the color point after color gamut transformation (not shown) may be transformed into image signal (R^{out}, G^{out}, B^{out}), and the computing unit 20 may transmit the image signal (R^{out}, G^{out}, B^{out}) to the display panel 40. The gamma unit 30 may adjust the gamma curves provided to the driving unit 70 based on the three adjustment factors K_{R}, K_{G} and K_{B} corresponding to red, green and blue colors. The driving unit 70 generates the data signal DN provided to the red sub-pixel 61, the green sub-pixel 62 and the blue sub-pixel 63 based on the image signal (R^{out}, G^{out}, B^{out}) and the gamma curves, and the backlight unit 50 adjusts backlight brightness based on the brightness adjustment factor K_{L}.

Accordingly, the fourth embodiment can be understood.

The display device 1 of the present disclosure may have different implementation aspects. FIG. 5 is a schematic diagram of the display device 1 according to the fifth embodiment of the present disclosure. The description of the embodiment of FIG. 5 is generally applicable to the embodiment of FIG. 4A, and thus the following description mainly focuses on the differences.

As shown in FIG. 5, the display device 1 may include a color temperature sensor 10, a computing unit 20, a gamma unit 30 and a display panel 40. The computing unit 20 may include a TRC transformation module 21, a color space transformation module 22, a white point transformation module 23, a color space inverse transformation module 24, a TRC inverse transformation module 25 and a color gamut transformation module 26. The display panel 40 may include red sub-pixels 61, green sub-pixels 62 and blue sub-pixels 63, and the display panel 40 may include a driving unit 70. In the embodiment of FIG. 5, the display panel 40 is a self-luminous display panel; that is, the red sub-pixel 61, the green sub-pixel 62 and the blue sub-pixel 63 each include a light-emitting unit, so that the backlight unit 50 of the aforementioned embodiment is not required.

Next, the operation of the computing unit 20 will be described, and please refer to FIG. 4B and FIG. 5 at the same time. In one embodiment, a signal source (not shown) may provide original image signal (Rⁱⁿ, Gⁱⁿ, Bⁱⁿ) to the computing unit 20. The color temperature sensor 10 may sense the color temperature of the ambient light to output target white point information (at least one of (X′, Y′, Z′) and (CCT), but not limited thereto). In addition, the computing unit 20 may obtain the information of the color space corresponding to the display panel 40 displaying a solid color screen, and obtain the actual white point in the color space. Then, the TRC transformation module 21 may perform TRC transformation on the original image signal (Rⁱⁿ, Gⁱⁿ, Bⁱⁿ) to form the first transformation signal (R′, G′, B′). Then, the color space transformation module 22 may transform the first transformation signal (R′, G′, B′) into color point (X, Y, Z) in the corresponding color space of the display panel 40. Then, the white point transformation module 23 may calculate three adjustment factors K_{R}, K_{G}, K_{B} corresponding to red, green and blue colors based on the target white point information (at least one of (X′, Y′, Z′) and (CCT), but not limited thereto), wherein the white point transformation module 23 may perform white point transformation on the actual white point based on target white point information (at least one of (X′, Y′, Z′) and (CCT), but not limited thereto), and calculate the three adjustment factors K_{R}, K_{G}, K_{B} and brightness adjustment factor K_{L} corresponding to red, green and blue colors from the transformation process. Then, the computing unit 20 may transmit the three adjustment factors K_{R}, K_{G} and K_{B} corresponding to red, green and blue colors to the gamma unit 30, and transmit the brightness adjustment factor K_{L} to the display panel 40. In addition, the color gamut transformation module 26 may perform color gamut transformation on the color point (X, Y, Z) based on the target color gamut so as to form the color point after color gamut transformation (not shown). Then, through the operation of the color space inverse transformation module 24 and the TRC inverse transformation module 25, the color point after color gamut transformation may be transformed into image signal (R^{out}, G^{out}, B^{out}), and the computing unit 20 may transmit the image signal (R^{out}, G^{out}, B^{out}) to the display panel 40. The gamma unit 30 may adjust the gamma curves provided to the driving unit 70 based on the three adjustment factors K_{R}, K_{G} and K_{B} corresponding to red, green and blue colors. The driving unit 70 generates the data signal DN provided to the red sub-pixel 61, the green sub-pixel 62 and the blue sub-pixel 63 based on the image signal (R^{out}, G^{out}, B^{out}) and the gamma curves, and the display panel 40 adjusts the brightness of the red sub-pixel 61, the green sub-pixel 62 and the blue sub-pixel 63 based on the brightness adjustment factor K_{L}.

In one embodiment, the circuit structure and brightness adjustment method of the red sub-pixel 61, the green sub-pixel 62 and the blue sub-pixel 63 may be applicable to the description of FIG. 3B and FIG. 3C, and thus a detailed description is deemed unnecessary.

The fifth embodiment may provide the same effects as the fourth embodiment, and may have a self-luminous function. Accordingly, the fifth embodiment can be understood.

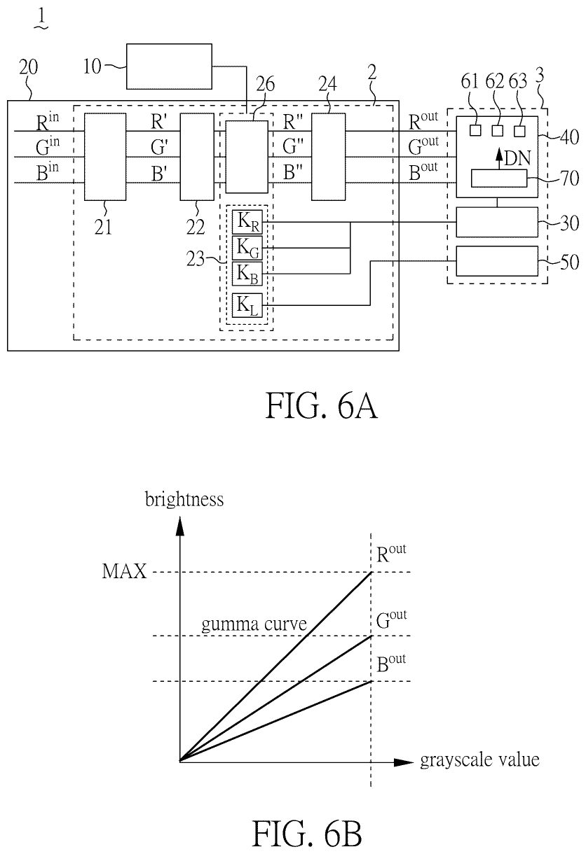

The display device 1 of the present disclosure may have different implementation aspects. FIG. 6A is a schematic diagram of the display device 1 according to the sixth embodiment of the present disclosure. The description of the embodiment of FIG. 6A is generally applicable to the embodiment of FIG. 4A, and thus the following description mainly focuses on the differences.

As shown in FIG. 6A, the display device 1 may include a color temperature sensor 10, a computing unit 20, a gamma unit 30, a display panel 40 and a backlight unit 50. The computing unit 20 may include a TRC transformation module 21, a color space transformation module 22, a white point transformation module 23, a color space inverse transformation module 24 and a color gamut transformation module 26. The display panel 40 may include red sub-pixels 61, green sub-pixels 62 and blue sub-pixels 63, and the display panel 40 may include a driving unit 70.

Next, the operation of the computing unit 20 will be described, and please refer to FIG. 4B again. As shown in FIG. 6A and FIG. 4B, in one embodiment, a signal source (not shown) may provide original image signal (Rⁱⁿ, Gⁱⁿ, Bⁱⁿ) to the computing unit 20. The color temperature sensor 10 may sense the color temperature of the ambient light so as to output target white point information (at least one of (X′, Y′, Z′) and (CCT), but not limited thereto). In addition, the computing unit 20 may obtain the information of the color space corresponding to the display panel 40 displaying a solid color screen, and obtain the actual white point in the color space. Then, the TRC transformation module 21 may perform TRC transformation on the original image signal (Rⁱⁿ, Gⁱⁿ, Bⁱⁿ) to form the first transformation signal (R′, G′, B′). Then, the color space transformation module 22 may transform the first transformation signal (R′, G′, B′) into color point (X, Y, Z) in the corresponding color space of the display panel 40. Then, the white point transformation module 23 may calculate three adjustment factors K_{R}, K_{G}, K_{B} corresponding to red, green and blue colors based on the target white point information (at least one of (X′, Y′, Z′) and (CCT), but not limited thereto), wherein the white point transformation module 23 may perform white point transformation on the actual white point based on the target white point information (at least one of (X′, Y′, Z′) and (CCT), but not limited thereto), and calculate the three adjustment factors K_{R}, K_{G}, K_{B}, and brightness adjustment factor K_{L} corresponding to red, green and blue colors from the transformation process. Then, the computing unit 20 may transmit the three adjustment factors K_{R}, K_{G} and K_{B} corresponding to red, green and blue to the gamma unit 30, and transmit the brightness adjustment factor K_{L} to the backlight unit 50. In addition, the color gamut transformation module 26 may perform color gamut transformation on the color point (X, Y, Z) based on the target color gamut so as to form the color point after color gamut transformation (not shown). Next, the color space inverse transformation module 24 transforms the color point after color gamut transformation into image signal (R^{out}, G^{out}, B^{out}), and the computing unit 20 may directly transmits the image signal (R^{out}, G^{out}, B^{out}) to the display panel 40 without performing TRC inverse transformation. The gamma unit 30 may adjust the gamma curves provided to the driving unit 70 based on the three adjustment factors K_{R}, K_{G} and K_{B} corresponding to red, green and blue colors. The driving unit 70 generates the data signal DN provided to the red sub-pixel 61, the green sub-pixel 62 and the blue sub-pixel 63 based on the image signal (R^{out}, G^{out}, B^{out}) and the gamma curves, and the backlight unit 50 adjusts backlight brightness based on the brightness adjustment factor K_{L}. In one embodiment, the TRC inverse transformation may be performed by the gamma unit 30 or the display panel 40, while it is not limited thereto.

FIG. 6B is a schematic diagram of the gamma curves of the display panel 40 according to an embodiment of the present disclosure, which may correspond to FIG. 6A. In this embodiment, the computing unit 20 does not perform TRC inverse transformation on the image signal (R^{out}, G^{out}, B^{out}), and thus the gamma curves corresponding to red, green and blue colors may all be linear. In one embodiment, the gamma unit 30 may adjust the gamma value of the gamma curve to a value based on the adjustment factors K_{R}, K_{G} and K_{B}, for example, the gamma value is 1, while it is not limited thereto.

Accordingly, the sixth embodiment can be understood.

The display device 1 of the present disclosure may have different implementation aspects. FIG. 7 is a schematic diagram of the display device 1 according to the seventh embodiment of the present disclosure. The description of the embodiment of FIG. 7 is generally applicable to the embodiment of FIG. 6A, and thus the following description mainly focuses on the differences.

As shown in FIG. 7, the display device 1 may include a color temperature sensor 10, a computing unit 20, a gamma unit 30 and a display panel 40. The computing unit 20 may include a TRC transformation module 21, a color space transformation module 22, a white point transformation module 23, a color space inverse transformation module 24 and a color gamut transformation module 26. The display panel 40 may include red sub-pixels 61, green sub-pixels 62 and blue sub-pixels 63, and the display panel 40 may include a driving unit 70. The display panel 40 of this embodiment is a self-luminous display panel.

The operation of the computing unit 30 of this embodiment may be substantially referred to the description of the embodiment of FIG. 6A, and the difference is that this embodiment does not have a backlight unit 50, so that the computing unit 20 may transmit the brightness adjustment factor K_{L} to the display panel 40, and the display panel 40 may adjust the brightness of the red sub-pixel 61, the green sub-pixel 62 and the blue sub-pixel 63 based on the brightness adjustment factor K_{L}.

As a result, the seventh embodiment may provide the same effects as the sixth embodiment, and may have a self-luminous function. Accordingly, the seventh embodiment can be understood.

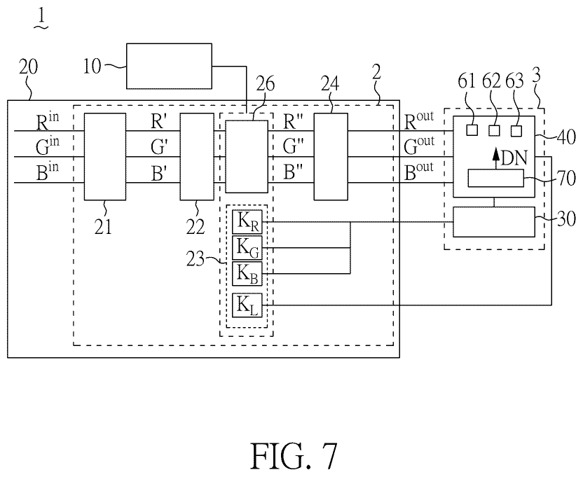

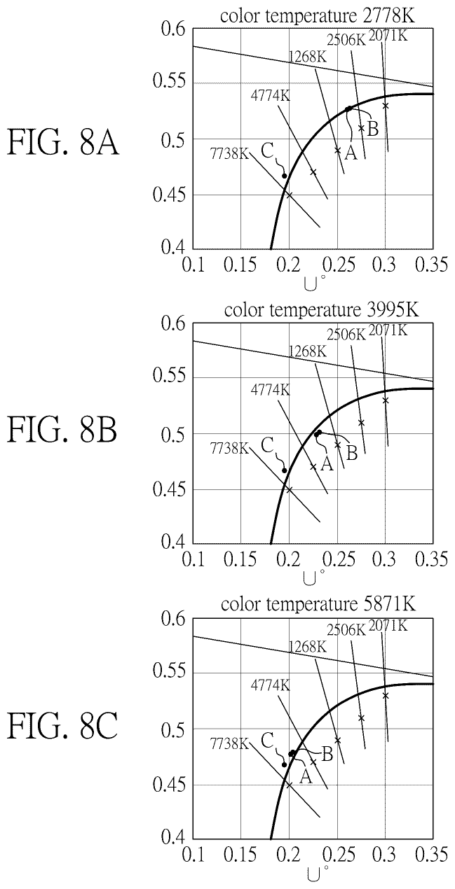

FIG. 8A to FIG. 8C are respectively schematic diagrams of the display device 1 displaying a color point (for example, but not limited to, a white point) of a white screen under different color temperatures of ambient light according to an embodiment of the present disclosure, and please refer to FIG. 1 to FIG. 7C at the same time. In FIG. 8A to FIG. 8C, a real color point in the ambient light (hereinafter referred to as the target color point) is denoted as A, the color point displayed by the display device 1 when the computing unit 20 executes the aforementioned driving method is denoted as B, and the color point displayed by the display device 1 when the computing unit 20 does not execute the aforementioned driving method is denoted as C. In addition, in FIG. 8A to FIG. 8C, the CIE1976u′v′ color space is taken as an example to present the chromaticity difference between the color point of the ambient light and the color point displayed by the display device 1.

As shown in FIG. 8A to FIG. 8C, when the color temperature of the ambient light is 2778K, 3995K or 5871K, the position of the color point A of the ambient light in the color space is substantially close to the position of the color point B of the white screen displayed by the display device 1 (when the computing unit 20 executes the aforementioned driving method), and the position of color point A is far away from the color point C of the white screen displayed by the display device 1 (when the computing unit 20 does not execute the aforementioned driving method). It can be seen that the chromaticity difference between color point A and color point B is smaller than the chromaticity difference between color point A and color point C.

In one embodiment, the chromaticity difference among color point A, color point B and color point C may satisfy the formula:

$$Δ {u}^{′} {v}_{20}^{′} < Δ {u}^{′} {v}_{10}^{′} ,$$

$$and Δ {u}^{′} {v}_{10}^{′} = \sqrt{{( {u}_{1}^{′} - {u}_{0}^{′} )}^{2} + {( {v}_{1}^{′} - {v}_{0}^{′} )}^{2}} ,$$

$$and Δ {u}^{′} {v}_{20}^{′} = \sqrt{{( {u}_{2}^{′} - {u}_{0}^{′} )}^{2} + {( {v}_{2}^{′} - {v}_{0}^{′} )}^{2}} ,$$

where Δu′v′₁₀ represents the chromaticity difference between the screen displayed on the display panel 40 and the ambient light when the computing unit 20 does not execute the aforementioned driving method, Δu′v′₂₀ is the chromaticity difference between the screen displayed on the display panel 40 and the ambient light when the computing unit 20 executes the aforementioned driving method, (u′₀, v′₀) represents the chromaticity of the ambient light, (u′₁, v′₁) represents the chromaticity of the screen displayed by the display panel 40 when the computing unit 20 does not execute the aforementioned driving method, and (u′₂, v′₂) represents the chromaticity of the screen displayed by the display panel 40 when the computing unit 20 executes the aforementioned driving method.

Accordingly, when the computing unit 20 executes the aforementioned driving method, the color temperature of the screen displayed on the display panel 40 may be changed with the color temperature of the ambient light, and the user may feel as if he/she is viewing a physical object under ambient light, which can enhance the user's sense of immersion.

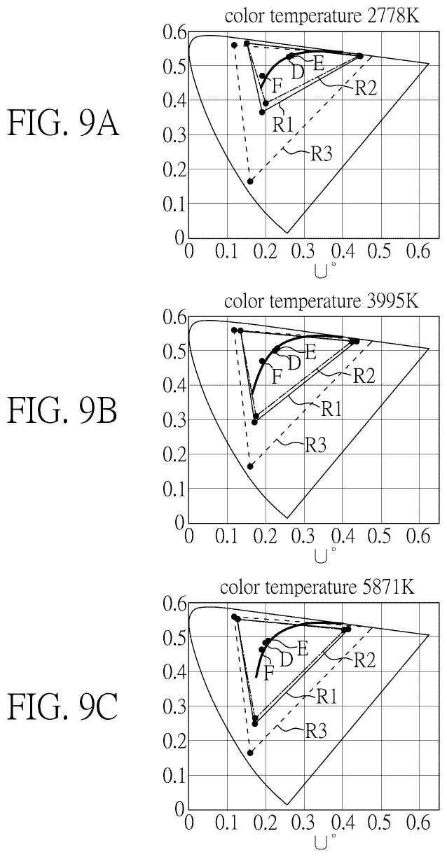

FIG. 9A to FIG. 9C are respectively schematic diagrams of a color point (for example, a WRGB color point) of the display device 1 (displaying an original content) under different ambient light color temperatures according to an embodiment of the present disclosure, and please refer to FIG. 1 to FIG. 8C at the same time. In FIG. 9A to FIG. 9C, a real color point of the original content under ambient light (hereinafter referred to as the target color point) is denoted as D, the color point of the white screen displayed by the display device 1 when the computing unit 20 executes the aforementioned driving method is denoted as E, and the color point of the white screen displayed by the display device 1 when the computing unit 20 does not execute the aforementioned driving method is denoted as F. In addition, the color gamut of the original content under ambient light is denoted as R1, the color gamut provided by the display device 1 when the color gamut transformation module 26 is in operation is denoted as R2, and the color gamut provided by the display device 1 when the color gamut transformation module 26 is not in operation is denoted as R3. In addition, in FIG. 9A to FIG. 9C, the color space CIE1976u′v′ is taken as an example to represent the chromaticity difference between the color point of the ambient light and the color point displayed by the display device 1.

As shown in FIG. 9A to FIG. 9C, when the color temperature of the ambient light is 2778K, 3995K or 5871K, the position of the color point D of the ambient light in the color space is substantially close to the position of the color point E of the white screen displayed by the display device 1 (when the computing unit 20 executes the aforementioned driving method), and the position of the color point D is far away from the color point F of the white screen displayed by the display device 1 (when the computing unit 20 does not execute the aforementioned driving method). It can be seen that the chromaticity difference between color point D and color point E is smaller than the chromaticity difference between color point D and color point F. In addition, when the color gamut transformation module 26 is in operation, the color gamut R2 provided by the display device 1 is close to the color gamut R1 of the original content under ambient light. When the color gamut transformation module 26 is not in operation, the color gamut R3 provided by the display device 1 is quite different from the color gamut R1 of the original content under ambient light. It can be seen from this that the operation of the color gamut transformation module 26 may make the screen displayed by the display device 1 closer to the appearance of the original content under ambient light.

In one embodiment, the chromaticity differences of color point D, color point E and color point F may satisfy the formula:

$$Δ {u}^{′} {v}_{53}^{′} < Δ {u}^{′} {v}_{43}^{′} ,$$

$$and Δ {u}^{′} {v}_{43}^{′} = \sqrt{{( {u}_{4}^{′} - {u}_{3}^{′} )}^{2} + {( {v}_{4}^{′} - {v}_{3}^{′} )}^{2}} ,$$

$$and Δ {u}^{′} {v}_{53}^{′} = \sqrt{{( {u}_{5}^{′} - {u}_{3}^{′} )}^{2} + {( {v}_{5}^{′} - {v}_{3}^{′} )}^{2}} ,$$

where Δu′v′₄₃ is the chromaticity difference between the screen displayed by the display panel 40 and the original content under ambient light when the computing unit 20 does not execute the aforementioned driving method, Δu′v′₅₃ is the chromaticity difference between the screen displayed on the display panel 40 and the original content under ambient light when the computing unit 20 executes the aforementioned driving method, (u′₃, v′₃) is the chromaticity of the original content under ambient light, (u′₄, v′₄) is the chromaticity of the screen displayed by the display panel 40 when the computing unit 20 does not execute the aforementioned driving method, and (u's, V's) is the chromaticity of the screen displayed by the display panel 40 when the computing unit 20 executes the aforementioned driving method.

Thus, when the computing unit 20 executes the aforementioned driving method, the color temperature of the screen displayed by the display panel 40 may change with the color temperature of the ambient light, and the color of the screen may be close to the color of the physical object under ambient light, so that users may feel as if they are viewing physical objects under ambient light, thereby enhancing the user's sense of immersion.

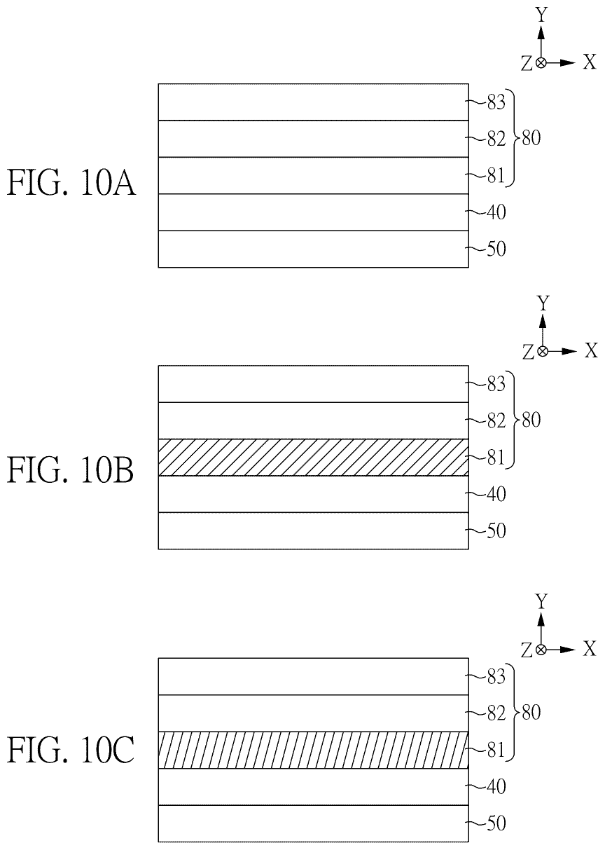

In addition, the display panel 40 of the present disclosure may be equipped with a special optical structure layer to improve the display quality. FIG. 10A is a schematic structural diagram of the display device 1 according to an embodiment of the present disclosure, and please refer to FIG. 1 to FIG. 9C at the same time.

As shown in FIG. 10A, the structure of the display device 1 may include a display panel 40 and an optical structure layer 80, wherein the optical structure layer 80 includes a protective layer 81, an anti-glare layer 82 and an anti-reflection layer 83. In the Y direction, the protective layer 81 is provided on the display panel 40, the anti-glare layer 82 is provided on the protective layer 81, and the anti-reflection layer 83 is provided on the anti-glare layer 82. The protective layer 81 may be, for example, a glass cover, but it is not limited thereto. Through the appropriate combination of the display panel 40, the protective layer 81, the anti-glare layer 82 and the anti-reflection layer 83, the display device 1 may provide a paper display effect, or may significantly reduce reflected light and glare.

In one embodiment, the anti-glare layer 82 and the glass cover (protective layer 81) may form an anti-glare glass, wherein the glossiness of the anti-glare glass may be between 10 GU and 50 GU (gloss unit). That is, 10 GU≤glossiness of anti-glare glass≤50 GU, while it is not limited thereto. In one embodiment, the transmittance of the anti-glare glass may be greater than or equal to 90%, that is, 90%≤transmittance of anti-glare glass, while it is not limited thereto.

In one embodiment, the glossiness of the optical structure layer 80 formed by the glass cover plate (protective layer 81), anti-glare layer 82 and anti-reflection layer 83 may be between 4 GU and 35 GU, that is, 4 GU≤glossiness of optical structure layer 80≤35 GU. In one embodiment, the glossiness of the optical structure layer 80 may be between 4 GU and 30 GU, that is, 4 GU≤glossiness of optical structure layer≤30 GU. In one embodiment, the glossiness of the optical structure layer 80 may be between 4 GU and 20 GU, that is, 4 GU≤glossiness of optical structure layer≤20 GU. However, the present disclosure is not limited thereto. In addition, in one embodiment, the transmittance of the optical structure layer 80 may be between 70% and 95%, that is, 70%≤transmittance of optical structure layer≤95%. In addition, in one embodiment, the reflectivity of the optical structure layer 80 may be less than or equal to 6%, that is, 6%≤reflectivity of optical structure layer. In one embodiment, the specular component included (SCI) reflectivity of the optical structure layer 80 may be between 3% and 6%, that is, 3%≤SCI reflectivity of optical structure layer≤6%. In one embodiment, the SCI reflectivity of the optical structure layer 80 may be between 4% and 6%, that is, 4%≤SCI reflectivity of optical structure layer≤6%. However, the present disclosure is not limited thereto.

In one embodiment, the display panel 40 and the optical structure layer 80 may form a display module, the glossiness of which may be less than or equal to 10 GU, that is, 10 GU≥glossiness of display module, which is, for example, 5 GU. In one embodiment, the SCI reflectivity of the display module may be less than or equal to 3%, that is, 3%≥SCI reflectivity of display module. In one embodiment, the specular component excluded (SCE) reflectivity of the display module may be greater than or equal to 0.6 times its SCI reflectivity, that is, SCE reflectivity of display module≥0.6*SCI reflectivity of display module. Accordingly, the reflected light of the display device 100 may be reduced so as to improve the visual quality.

In one embodiment, the display device 1 may be a bendable or flexible electronic device, and may be a non-self-luminous type or a self-luminous type. The display device 1 may include a light emitting unit, such as an organic light emitting diode (OLED), a sub-millimeter light emitting diode (mini LED), a micro light emitting diode (micro LED) or a quantum dot light emitting diode (quantum dot LED), but it is not limited thereto. The display technology of the display module may adopt liquid crystal display (liquid crystal display, LCD) technology, OLED display technology, mini LED display technology, micro LED display technology, cholesteric liquid crystal display (ChlLCD), electrophoretic display (EPD) technology and the like. According to the type of display technology, the display device 1 may or may not have the backlight module 50, while it is not limited thereto. In one embodiment, the size of the chip of the light emitting diode (LED) is about 300 micrometers to 10 millimeters (that is, 300 μm≤size≤10 mm), and the size of the mini LED chip is about 100 micrometers to 300 micrometers (that is, 100 μm≤size≤300 μm), and the size of the micro LED chip is about 1 micrometer to 100 micrometers (that is, 1 μm≤size≤100 μm), while it is not limited thereto.

FIG. 10B is a schematic structural diagram of a display device 1 according to another embodiment of the present disclosure, and please refer to FIG. 1A to FIG. 10A at the same time. The embodiment in FIG. 10B is generally applicable to the description of the embodiment in FIG. 10A, and thus the following description mainly focuses on the different features.

As shown in FIG. 10B, the protective layer 81 of the optical structure layer 80 may be, for example, a cover film, but it is not limited thereto. In one embodiment, the anti-glare layer 82 and the cover film (protective layer 81) may form an anti-glare film, wherein the glossiness of the anti-glare film may be between 10 GU and 50 GU, that is, 10 GU≤glossiness of anti-glare film≤50 GU, while it is not limited thereto. In one embodiment, the transmittance of the anti-glare film may be greater than or equal to 90 percent (%), that is, 90%≤transmittance of anti-glare film, while it is not limited thereto. In addition, in the embodiment of FIG. 10B, the glossiness, transmittance, reflectivity, and SCI reflectivity of the optical structure layer 80 may be applicable to the description of the embodiment of FIG. 10A. In addition, the glossiness, SCI reflectivity or SCE reflectivity of the display module formed by the display panel 40 and the optical structure layer 80 may also be applicable to the description of the embodiment of FIG. 10A.

FIG. 10C is a schematic structural diagram of a display device 1 according to another embodiment of the present disclosure, and please refer to FIG. 1A to FIG. 10B at the same time. The embodiment in FIG. 10C is generally applicable to the description of the embodiment in FIG. 10A, and thus the following description mainly focuses on the different features.

As shown in FIG. 10C, the protective layer 81 of the optical structure layer 80 may be, for example, a polarizer, but it is not limited thereto. In one embodiment, the anti-glare layer 82 and the polarizer (protective layer 81) may form an anti-glare polarizer sheet, wherein the glossiness of the anti-glare polarizer sheet may be between 10 GU and 50 GU, that is, 10 GU≤glossiness of anti-glare polarizer sheet≤50 GU, while it is not limited thereto. In one embodiment, the transmittance of the anti-glare polarizer sheet may between 45% and 60%, that is, 45%≤transmittance of anti-glare polarizer sheet≤60%, while it is not limited thereto. In addition, in the embodiment of FIG. 10C, the glossiness, transmittance, reflectivity, and SCI reflectivity of the optical structure layer 80 may be applicable to the description of the embodiment of FIG. 10A. In addition, the glossiness, SCI reflectivity or SCE reflectivity of the display module formed by the display panel 40 and the optical structure layer 80 may also be applicable to the description of the embodiment of FIG. 10A.

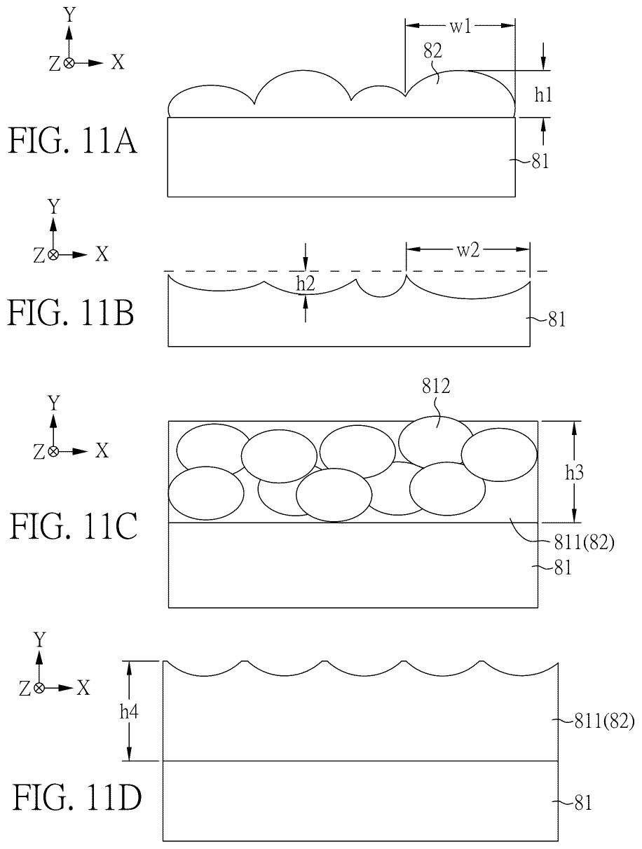

Next, the details of the protective layer 81 and the anti-glare layer 82 will be described. FIG. 11A and FIG. 11B are respectively schematic structural diagrams of the protective layer 81 and the anti-glare layer 82 according to an embodiment of the present disclosure, and please also refer to FIG. 1A to FIG. 10C. FIG. 11A and FIG. 11B may be used to illustrate the details of the anti-glare glass formed by the protective layer 81 and the anti-glare layer 82 in the form of a glass cover.

As shown in FIG. 11A, in one embodiment, the anti-glare layer 82 may be disposed on the glass cover (protective layer 81) by spraying. In one embodiment, “spraying” is, for example, applying a specific solution for forming the anti-glare layer 82 to a surface of the glass cover (protective layer 81) so as to create a raised structure on the surface, and then using high temperature to apply the specific solution to the surface of the glass cover (protective layer 81). The solution and the glass cover (protective layer 81) are then solidified, thereby forming anti-glare glass having an anti-glare layer 82. In one embodiment, the specific solution may be, for example, silicon dioxide (SiO2), but it is not limited thereto. In addition, in one embodiment, the anti-glare layer 82 formed by spraying may have a plurality of raised structures, wherein the width w1 of each raised structure (for example, the distance between peaks or between valleys of each raised structure) may be between 5 micrometers and 20 micrometers, that is, 5 um≤w1≤20 um, while it is not limited thereto. In one embodiment, the height h1 of each raised structure in the Y direction may be between 0.1 micrometers and 0.5 micrometers, that is, 0.1 um≤h1≤0.5 um, while it is not limited thereto. Accordingly, the anti-glare layer 82 may provide an excellent anti-glare effect.

As shown in FIG. 11B, in one embodiment, the surface of the glass cover (protective layer 81) may be roughened by etching, thereby producing an effect similar to the anti-glare layer 82. In one embodiment, “etching” is, for example, using an acidic substance to corrode the film layer on the surface of the glass cover (protective layer 81), thereby creating a recessed structure on the film layer, thereby forming an anti-glare glass with the effect similar to the anti-glare layer 82 (recessed). It can be seen from this that the structure of the embodiment of FIG. 11B may achieve an effect similar to the anti-glare layer 82 by etching the protective layer 81, and thus there is no need to have an actual anti-glare layer 82. In one embodiment, the surface of the protective layer 81 may have a plurality of recessed structures after being roughened by etching, wherein the width w2 of each recessed structure (such as the distance between peaks or between valleys of each recessed structure) may be between 5 micrometers and 20 micrometers, that is, 5 um≤w2≤20 um, while it is not limited thereto. In one embodiment, the depth h2 of each recessed structure in the Y direction may be between 0.1 micrometers and 0.5 micrometers, that is, 0.1 um≤h2≤0.5 um, while it is not limited thereto. Accordingly, the surface of the protective layer 81 may provide an anti-glare effect similar to that of the anti-glare layer 82.

FIG. 11C and FIG. 11D are respectively schematic structural diagrams of the protective layer 81 and the anti-glare layer 82 according to another embodiment of the present disclosure, and please refer to FIG. 1A to FIG. 11B at the same time. FIG. 11C and FIG. 11D may be used to illustrate the details of the anti-glare film formed by the cover film (protective layer 81) and the anti-glare layer 82.

As shown in FIG. 11C, in one embodiment, the cover film (protective layer 81) may have a hard coating layer 811, and the anti-glare layer 82 may be formed by mixing specific particulate matter 812 into the hard coating layer 811 to generate raised structures and recessed structures. In one embodiment, the hard coating layer 811 may have a maximum thickness h3 after generating the raised structures and recessed structures. The maximum thickness h3 may be between 1 micrometer and 3 micrometers, that is, 1 um≤h3≤3 um, while it is not limited thereto. In one embodiment, the type of specific particulate matter 812 may include, for example, silicon dioxide particles, while it is not limited thereto.

As shown in FIG. 11D, in one embodiment, the cover film (protective layer 81) may have a hard coating layer 811, and the anti-glare layer 82 may be formed by applying nano-imprint technology on the hard coating layer 811 to generate recessed structures on the hard coat layer 811. In one embodiment, the hard coating layer 811 may have a maximum thickness h4 after generating the recessed structures. The maximum thickness h4 may be between 1 micrometer and 3 micrometers, that is, 1 um≤h4≤3 um, while it is not limited thereto.

Next, the details of the anti-reflection layer 83 will be described, and please refer to FIG. 10A to FIG. 10C again. In one embodiment, the anti-reflection layer 83 may be formed by using physical vapor deposition (PVD) technology to coat a plurality of film layers with different refractive indexes on the surface of the anti-glare layer 82. In one embodiment, the anti-reflection layer 83 may include multiple high refractive index sub-layers and multiple low refractive index sub-layers, wherein the high refractive index sub-layers and the low refractive index sub-layers may be stacked alternately, while it is not limited thereto. The high refractive index sub-layer or the low refractive index sub-layer may include metal oxide or dielectric material, while it is not limited thereto. In one embodiment, the outermost sub-layer of the anti-reflection layer 83 in the display direction is a low refractive index sub-layer, while it is not limited thereto. In one embodiment, the total number of high refractive index sub-layers and low refractive index sub-layers is at least four layers, while it is not limited thereto. In one embodiment, the refractive index of the high refractive index sub-layer is higher than the refractive index of the low refractive index sub-layer. For example, the refractive index value of the high refractive index sub-layer may be between 1.9 and 2.4, that is, 1.9≤refractive index value of high refractive index sub-layer≤2.4, and the refractive index value of the low refractive index sub-layer may be between 1.2 and 1.5, that is, 1.2≤refractive index value of low refractive index sub-layer≤1.5, while it is not limited thereto.

In one embodiment, the anti-reflection layer 83 may be a non-smoke anti-reflection layer (non-smoke AR layer). In one embodiment, the material of the high refractive index sub-layer of the non-smoke AR layer may include niobium pentoxide (Nb2O5), while it is not limited thereto. The material of the low-refractive index sub-layer of the non-smoke AR layer may include silicon dioxide (SiO2), while it is not limited thereto. In one embodiment, the sub-layer configuration of the anti-reflection layer 33 in the form of a non-smoke AR layer may be as shown in Table 1. It should be noted that the parameters and the number of sub-layers in Table 1 are only for illustrative purpose but not limitation

TABLE 1

| | Thickness of sub-layers of non- |
|---|---|
| Configuration of sub-layers of non- | smoke AR layer (unit: nanometer |
| smoke AR layer | (nm) |
| Low refractive index sub-layer | 86.7 |
| (material: silicon dioxide) | |
| High refractive index sub-layer | |
| (material: niobium pentoxide) | |
| Low refractive index sub-layer | 36.00 |
| (material: silicon dioxide) | |
| High refractive index sub-layer | 11.7 |
| (material: niobium pentoxide) | |
| Glass substrate (including anti-glare | any configuration |
| layer 82 and protective layer 81) | |

In another embodiment, the anti-reflection layer 83 may be a smoke AR layer. In one embodiment, the material of the high refractive index sub-layer of the smoke AR layer may include a transparent conductive film (indium tin oxide, ITO), while it is not limited thereto. In one embodiment, the material of the low refractive index sub-layer of the smoke AR layer may include silicon dioxide, while it is not limited thereto. In one embodiment, the high refractive index sub-layer of the smoke AR layer has an extinction coefficient k, wherein the extinction coefficient k may be between 0.01 and 0.05, that is, 0.01≤k≤0.05, while it is not limited thereto. In addition, the low refractive index sub-layer may have substantially no extinction properties. In one embodiment, the configuration of the sub-layers of the anti-reflection layer 83 (smoke AR layer) may be as that shown in Table 2. It should be noted that the parameters and the number of sub-layers in Table 2 are only for illustrative purpose but not limitation.

TABLE 2

| Configuration of sub-layers | Thickness of sub-layers of smoke |
|---|---|
| of smoke AR layer | AR layer (unit: nanometer (nm)) |
| Low refractive index sub-layer | 84.2 |
| (material: silicon dioxide) | |
| High refractive index sub-layer | 72.09 |
| (material: niobium pentoxide) | |
| Low refractive index sub-layer | 14.14 |
| (material: silicon dioxide) | |
| High refractive index sub-layer | 25.73 |
| (material: niobium pentoxide) | |
| Low refractive index sub-layer | 134.55 |
| (material: silicon dioxide) | |
| High refractive index sub-layer | 15.07 |
| (material: niobium pentoxide) | |
| Low refractive index sub-layer | 27.56 |
| (material: silicon dioxide) | |
| High refractive index sub-layer | 259.91 |
| (material: niobium pentoxide) | |
| Low refractive index sub-layer | 24.96 |
| (material: silicon dioxide) | |
| High refractive index sub-layer | 21.47 |
| (material: niobium pentoxide) | |
| Glass substrate (including anti-glare | any configuration |
| layer 82 and protective layer 81) | |

In addition, in one embodiment, the reflectivity of the anti-reflection layer 83 may be between 3 percent and 6 percent, that is, 3%≤reflectivity of anti-reflection layer≤6%, while it is not limited thereto. In one embodiment, the overall thickness of the anti-reflection layer 83 in the Y direction may be between 200 nm and 700 nm, that is, 200 nm≤overall thickness of anti-reflection layer≤700 nm, while it is not limited thereto.

Next, the details of the backlight unit 50 or the self-luminous display module (self-luminous display panel 40 and optical structure layer 80) of the present disclosure will be described.

In one embodiment, the backlight unit 50 may include a plurality of diffusion sheets and a light guide plate, wherein the diffusion sheets may be disposed on the light guide plate in the Y direction, while it is not limited thereto. In one embodiment, the number of diffusion sheets of the backlight unit 50 is at least two, while it is not limited thereto. In one embodiment, there is no other optical film layer disposed between the upper diffusion sheet and the lower diffusion sheet. In one embodiment, in the Y direction, a brightness enhancement film may be disposed above the diffusion sheet. The brightness enhancement film may be, for example, a dual brightness enhancement film (DBEF), while it is not limited thereto.

In one embodiment, the full width at half maximum (FWHM) of the viewing angle corresponding to the brightness of the backlight unit 50 or the self-luminous display module may be greater than 40 degrees, that is, 40°≤FWHM, for example, FWHM is 45 degrees, while it is not limited thereto. Here “full width at half maximum” refers to the angular difference between the viewing angle with half the maximum brightness and the zero-degree viewing angle.

Accordingly, the detailed features of the structure of the display device 1 of the present disclosure may be understood. It should be noted that the numerical values or dimensions, the outline of each layer, the structure of the transistor, the configuration of the circuit, etc. mentioned in the above description are only examples, and the present disclosure is not limited thereto.

In one embodiment, the present disclosure may determine whether a product in contention falls within the protection scope of the present disclosure at least by the presence or absence of components, component configurations, mechanism observation and/or operating modes of the product to determine whether it falls within the protection scope of the present disclosure, while it is not limited thereto.

The details or features of the various embodiments of the present disclosure may be mixed and matched as long as they do not violate the spirit of the invention or conflict with each other.

The aforementioned specific embodiments should be interpreted as merely illustrative, and not limiting the rest of the present disclosure in any way, and the features of different embodiments may be mixed and matched as long as they do not conflict with each other.

1. A display device, comprising:
a color temperature sensor for sensing color temperature of ambient light and outputting target white point information;
a computing unit coupled to the color temperature sensor for calculating three adjustment factors corresponding to red, green and blue colors based on the target white point information;
a gamma unit coupled to the computing unit for receiving the three adjustment factors and adjusting gamma curves corresponding to red, green and blue colors; and
a display panel including a red sub-pixel, a green sub-pixel and a blue sub-pixel, wherein the display panel is coupled to the gamma unit for receiving an image signal, and the display panel provides data signal to the red sub-pixel, the green sub-pixel and the blue sub-pixel based on the gamma curves corresponding to red, green and blue colors.

2. The display device as claimed in claim 1, further comprising a backlight unit, wherein the computing unit calculates a brightness adjustment factor based on the target white point information, and the backlight unit receives the brightness adjustment factor and adjusts backlight brightness provided to the display panel.

3. The display device as claimed in claim 1, wherein the display device displays image corresponding to an original content, the computing unit further includes a color gamut transformation module provided with a target color gamut of the original content under ambient light and coupled to the color temperature sensor, the computing unit receives an original image signal, and the original image signal is transformed into the image signal based on the target color gamut.

4. The display device as claimed in claim 3, wherein the original content includes a photo, a painting or a picture.

5. The display device as claimed in claim 1, wherein the computing unit calculates a brightness adjustment factor based on the target white point information, and the display panel receives the brightness adjustment factor and adjusts brightness of the red sub-pixel, the green sub-pixel and the blue sub-pixel.

6. The display device as claimed in claim 5, wherein each of the red sub-pixel, the green sub-pixel and the blue sub-pixel includes a driving transistor, an emission transistor and a light emitting unit, and the emission transistor is coupled between the driving transistor and the light emitting unit for receiving the brightness adjustment factor.

7. The display device as claimed in claim 1, further comprising an optical structure layer including a protective layer, an anti-glare layer and an anti-reflection layer, wherein the protective layer is disposed on the display panel, the anti-glare layer is disposed on the protective layer, and the anti-reflection layer is disposed on the anti-glare layer.

8. The display device as claimed in claim 7, wherein the glossiness of the optical structure layer is between 4 GU and 35 GU.

9. The display device as claimed in claim 7, wherein the transmittance of the optical structure layer is between 70% and 95%.

10. The display device as claimed in claim 7, wherein the anti-glare layer and the protective layer form an anti-glare glass, and a glossiness of the anti-glare glass is between 10 GU and 50 GU.

11. The display device as claimed in claim 1, wherein the computing unit includes:
a tone reproduction curve (TRC) transformation module for performing TRC transformation on an original image signal;
a color space transformation module for transforming the signal after TRC transformation into a color point in a color space;
a white point transformation module for calculating the adjustment factors and a brightness adjustment factor based on the target white point information, and using the adjustment factors to adjust the color point;
a color space inverse transformation module for transforming the adjusted color point into a new signal;
a TRC inverse transformation module for performing TRC inverse transformation on the new signal to generate the image signal; and
a backlight unit for receiving the brightness adjustment factor and adjusts backlight brightness provided to the display panel.

12. The display device as claimed in claim 1, wherein the computing unit includes:
a color space transformation module for finding an actual white point from a color space corresponding to the display panel;
a white point transformation module for calculating the adjustment factors and a brightness adjustment factor based on the target white point information; and
a backlight unit for receiving the brightness adjustment factor and adjusts backlight brightness provided to the display panel, wherein the image signal input to the display panel is an original image signal.

13. The display device as claimed in claim 1, wherein the display panel is a self-luminous display panel, and the computing unit includes:
a color space transformation module for finding an actual white point from a color space corresponding to the display panel; and
a white point transformation module for calculating the adjustment factors and a brightness adjustment factor based on the target white point information, and providing the brightness adjustment factor to the display panel, wherein the image signal input to the display panel is an original image signal.

14. The display device as claimed in claim 1, wherein the display device displays image corresponding to an original content, and the computing unit includes:
a TRC transformation module for performing TRC transformation on an original image signal to form a first transformation signal;
a color space transformation module for transforming the first transformation signal into a color point in a color space corresponding to the display panel;
a white point transformation module for calculating the adjustment factors and a brightness adjustment factor based on the target white point information;
a color gamut transformation module for performing color gamut transformation on the color point based on a target color gamut of the original content under ambient light to form a color point after color gamut transformation;
a color space inverse transformation module for transforming the color point after color gamut transformation into a new signal;
a TRC inverse transformation module for performing TRC inverse transformation on the new signal to generate the image signal, and a backlight unit for receiving the brightness adjustment factor and adjusts backlight brightness provided to the display panel.

15. The display device as claimed in claim 1, wherein the display device displays image corresponding to an original content, the display panel is a self-luminous display panel, and the computing unit includes:
a TRC transformation module for performing TRC transformation on an original image signal to form a first transformation signal;
a color space transformation module for transforming the first transformation signal into a color point in a color space corresponding to the display panel;
a white point transformation module for calculating the adjustment factors and a brightness adjustment factor based on the target white point information, and providing the brightness adjustment factor to the display panel;
a color gamut transformation module for performing color gamut transformation on the color point based on a target color gamut of the original content under ambient light to form a color point after color gamut transformation;
a color space inverse transformation module for transforming the color point after color gamut transformation into a new signal; and
a TRC inverse transformation module for performing TRC inverse transformation on the new signal to generate the image signal.

16. The display device as claimed in claim 1, wherein the display device displays image corresponding to an original content, and the computing unit includes:
a TRC transformation module for performing TRC transformation on an original image signal to form a first transformation signal;
a color space transformation module for transforming the first transformation signal into a color point in a color space corresponding to the display panel;
a white point transformation module for calculating the adjustment factors and a brightness adjustment factor based on the target white point information;
a color gamut transformation module for performing color gamut transformation on the color point based on a target color gamut of the original content under ambient light to form a color point after color gamut transformation;
a color space inverse transformation module for transforming the color point after color gamut transformation into the image signal, and a backlight unit for receiving the brightness adjustment factor and adjusts backlight brightness provided to the display panel.

17. The display device as claimed in claim 1, wherein the display device displays image corresponding to an original content, the display panel is a self-luminous display panel, and the computing unit includes:
a TRC transformation module for performing TRC transformation on an original image signal to form a first transformation signal;
a color space transformation module for transforming the first transformation signal into a color point in a color space corresponding to the display panel;
a white point transformation module for calculating the adjustment factors and a brightness adjustment factor based on the target white point information, and providing the brightness adjustment factor to the display panel;
a color gamut transformation module for performing color gamut transformation on the color point based on a target color gamut of the original content under ambient light to form a color point after color gamut transformation; and
a color space inverse transformation module for transforming the color point after color gamut transformation into the image signal.

18. The display device as claimed in claim 7, wherein the anti-glare layer has a plurality of raised structures, a width of each raised structure is between 5 micrometers and 20 micrometers, and a height of each raised structure is between 0.1 micrometers and 0.5 micrometers.

19. The display device as claimed in claim 7, wherein a surface of the protective layer 81 has a plurality of recessed structures, a width of each recessed structure is between 5 micrometers and 20 micrometers, and a depth of each recessed structure is between 0.1 micrometers and 0.5 micrometers.

20. The display device as claimed in claim 7, wherein the protective layer has a hard coating layer, the anti-glare layer is formed by mixing specific particulate matter into the hard coating layer to generate raised structures and recessed structures, and the hard coating layer has a maximum thickness of between 1 micrometer and 3 micrometers.
